(19) United States
(12) Patent Application Publication
(10) Pub. No.: US 2004/0208999 A1
(43) Pub. Date: Oct. 21, 2004

(54) Using a metered size press to produce lightweight coated rotogravure paper

(76) Inventors: Xiao-Qin Wang, Nanuet, NY (US); Debora R. Jeske, Highland Mills, NY (US)

Correspondence Address: Richard C. Stewart II, International Paper Company, 6285 Tri-Ridge Boulevard, Loveland, OH, 45140, US

(21) Appl. No.: 10/805,034

(22) Filed: Mar. 19, 2004

Related U.S. Application Data
(60) Provisional application No. 60/455,776, filed on Mar. 19, 2003.

(51) Int. Cl. B05D 3/02; B32B 29/00

(52) U.S. Cl. 427/372.2; 428/537.5

(57) ABSTRACT

A method for producing paper suitable for rotogravure printing by using a metered size press process to apply a coating formulation to a paper and then calendering the coated paper. In one aspect, the coating formulation comprises a pigment mixture containing engineered delaminated kaolin clay, and a latex binder. In another aspect, the pigment mixture comprises delaminated kaolin clay, engineered delaminated kaolin clay and calcined clay. Alternatively, talc is used in place of the calcined clay. In a further aspect, the pigment mixture comprises delaminated kaolin clay, platey kaolin clay, coarse kaolin clay and calcined clay.

### FIELD OF INVENTION

This invention generally relates to coated paper. More particularly, it relates to a method of using a metered size press for producing a lightweight coated paper suitable for rotogravure printing and the paper made using said method.

### BACKGROUND OF THE INVENTION

The prior art discloses different methods for producing rotogravure paper. See, for example: U.S. Pat. No. 5,861,209 to Haskins et al., U.S. Pat. No. 5,879,512 to McGenity et al., U.S. Pat. No. 4,575,477 to Werkema et al., U.S. Pat. No. 4,298,652 to Suzuki et al., and U.S. Pat. No.5, 996,489 to Leube et al. The paper used in the rotogravure printing process is normally a coated paper comprising a wood pulp web as the substrate and a coating. The coating on LWC paper used for rotogravure printing is generally applied using a blade coating process. In the blade coating process, an excess amount of coating is applied to the paper using a roll or nozzle and the excess coating is scraped off using a doctor blade. Blade coating produces a smooth surface on the paper allowing it to come in contact with the ink and pull it out of the cavities. While blade coating produces a LWC paper suitable for rotogravure printing, the blade coating process imparts high stresses upon the paper during coating. As such, blade coating requires a strong base paper. This calls for a paper that contains a high percentage of chemical pulp (e.g. kraft pulp) and less mechanical pulp and/or filler. This raises production costs since chemical pulp is expensive. An alternative to the use of a blade coater is the use of a metered size press (“MSP”), which is sometimes referred to as a metering size press or film press coater. In the MSP process, a coating is first applied (“metered”) by a metering rod onto an applicator roll. The applicator roll is then pressed against a paper in the nip of a size press roll. This transfers the coating to the paper. Unlike blade coating, MSP coating has no stationery elements (e.g. a blade) that are in contact with the paper. Thus, the stress on paper is minimal as compared to blade coating. This allows the use of a paper having less chemical pulp, which reduces production costs. Less stress on the paper results in fewer paper breaks during the coating process, which results in increased production efficiency. However, paper coated with MSP is usually exhibits inferior smoothness, skip dot and print gloss as compared to paper coated with a blade coater.

Therefore, it is highly desirable to provide a MSP process for making coated paper for use in rotogravure processes that is relatively inexpensive and which exhibits smoothness, skip dot and/or print gloss comparable to that of coated paper made in a blade coating process.

### SUMMARY OF THE INVENTION

One aspect of this invention relates to a method of producing a coated paper suitable for rotogravure printing which comprises steps of:

(a) Preparing an aqueous coating formulation comprising: (i) water, (ii) a first pigment having a shape factor of greater than about 15 or about 17 or mixture thereof with one of more second pigments having a shape factor less than that of the first clay pigment and equal to or less than about 15 to about 17 and having a pigment particle size distribution wherein at least about 80% by weight of the pigment particles have an equivalent spherical diameter of less than 2 microns, (iii) a polymeric binder, and (iv) preferably a coating structure agent;

(b) Using a metered size press to apply the aqueous coating formulation to one or both surfaces of a paper substrate having Gurley Porosity of from about 20 sec/100 ml to about 60 sec/100 ml;

(c) Drying the coated paper to a moisture level of less than about 9%; and

(d) Calendaring the dried coated paper to form a form a dried calendared paper having a smoothness (Parker at 10 kgf/cm2, microns) value equal to or less than 1.5 and a Heliotest (mm) value equal to or greater than about 89.

Another aspect of this invention relates to a coated paper suitable for rotogravure printing comprising:

(a) A paper substrate having a Gurley Porosity of from about 20 sec/100 ml to about 60 sec/100 ml and

(b) A coating on at least one side of said paper substrate, said coating comprising (i) Preparing an aqueous coating formulation comprising: (i) water, (ii) a first pigment having a shape factor of greater than about 15 or about 17 or mixture thereof with one of more second pigments having a shape factor less than that of the first clay pigment and equal to or less than about 15 to about 17 and having a pigment particle size distribution wherein at least about 80%, (ii) a polymeric binder, and (iii) preferably a coating structure agent,

Said paper having a smoothness (Parker at 10 kgf/cm2, microns) value equal to or less than about 1.5 and a Heliotest (mm) value equal to or greater than about 80.

In another aspect of the present invention relates to an aqueous coating formulation comprising: (i) water, (ii Preparing an aqueous coating formulation comprising: (i) water, (ii) a first pigment having a shape factor of greater than about 15 or about 17 or mixture thereof with one of more second pigments having a shape factor less than that of the first clay pigment and equal to or less than about 15 to about 17 and having a pigment particle size distribution wherein at least about 80%, (ii) a polymeric binder, and (iii) preferably a coating structure agent.

Yet another aspect of this invention relates to a method of generating images on a surface of a coated paper in a rotogravure printing apparatus that comprises:

(a) Incorporating the coated paper of this invention into said apparatus; and

(b) Forming an image on a surface of said coated paper by causing ink to be expelled from said apparatus onto said treated surface of the coated paper to form a coated paper having an image on a surface thereof.

The present invention exhibits one or more advantages over the prior art. For example, the process of this invention allows the efficient use of Metering Size Press to produce rotogravure paper having a smoothness, skip dot and/or Print Gloss substantially value equivalent to blade coated rotogravure paper but which may have a lower chemical pulp content than blade coated rotogravure paper and is therefore less.

### DETAILED DESCRIPTION OF THE INVENTION

The first step of the process of this invention comprises preparing an aqueous coating formulation. In addition to water, the essential components coating formulation are a clay pigment, platy clay, a polymeric binder and a coating structure agent. The percent solids of the coating composition may vary widely although higher percent solids are preferred. The percent solids are preferably equal to or greater than about 45%, more preferably from about 53% to about 61% and most preferably from about 56% to about 58%.

Methods and apparatuses for forming coating formulations are well known in the paper and paperboard art. See for example “Handbook For Pulp & Paper Technologies”, 2^{nd} Edition, G. A. Smook, Angus Wilde Publications (1992) and references cited therein. Any conventional method of forming coating formulations and apparatus can be used.

As one essential ingredient, the coating composition comprises a clay pigment. The amount of clay pigment in the coating composition may vary widely and conventional amounts can be employed. In the preferred embodiments of the invention, the amount of clay pigment is from about ______ to about ______% by wgt of the coating composition. The amount is more preferably from about ______ to about ______% by wgt of the composition and is most preferably from about 30 to about 95% by of the composition

Illustrative of useful clay pigments are those described in U.S. Pat. Nos. 6,616,749; 6,610,137; 6,564,199; 6,537,363; 6,514,333; 6,468,343; 6,402,826; 6,150,289; and 6,149,723, Also illustrative of useful clay pigments having the required shape factor and particle size distribution are those having a chemical composition of (OH)₈Si₄Al₄O₁₀, possessing 1:1 layer of alumina octahedral sheet and a silica tetrahedral sheet. The clay has an amphoteric surface, which not only has cationic exchange capacity, but also anionic exchange capacity. The silanol SiOH on the surface of the clay platelets generates a negative charge. The aluminol groups that locate on the edges of the platelets are positively charged at pH below 9. Preferred clays are kaolin clays such as delaminated kaolin clay, platy kaolin clay, coarse kaolin clay, fine clay, engineered delaminated kaolin clay, and calcined clay.

The pigment may be a first pigment having a shape factor having a shape factor of greater than about 15 or about as determined by conventional test and procedures for determining shape factor as for example the preferred “IMERYS” test. The “IMERYS” test is described in more detail in U.S. Pat. Nos. 5,128,606 and 5,576,617. The shape factor of the first clay pigment is preferably equal to or greater than about 17, more preferably from about 17 to about 70 and most preferably from about 21 to about 65 with a pigment shape factor of from about 21 to about 60 in the embodiments of choice. When the first pigment is used in the absence of the second pigment, the shape factor of the first pigment is preferably in a relatively intermediate range as for example from about 15 to about 30, from about 16 to about 30, from about 17 to about 25 and from about 17 to about 23.

Useful first clay pigments can be obtained from commercial sources or mined from naturally occurring deposits and engineered for the required shape factors and particle distribution. Illustrative of useful first clay pigments having the required shape factor and particle size are those sold under the trade names XP8000 and Capim NP from IMERYS and the clay sold under the trade name Century from CVRD. Preferred second clays are those sold under the trade names Capim NP and Century and the more preferred second clay is that sold under the trade name Century.

The pigment can also be a mixture of the first pigment and one of more second pigments having a shape factor less than that of the first clay pigment and equal to or less than about 15 to about 17 and having a pigment particle size distribution wherein at least about 80%. Useful pigment mixtures include those comprising about 95% by weight engineered delaminated clay (e.g. Capim NP) and about 5% by weight calcined clay. (e.g. Alphatex from IMERYS) Alternatively, the pigment mixture may contain about 50% by weight engineered delaminated clay and about 45% by weight delaminated clay (e.g. AstraPlate from IMERYS) instead of engineered delaminated clay. In another embodiment, the pigment mixture comprises about 25% by weight engineered delaminated clay (e.g. Capim NP) and about 45% by weight delaminated clay (e.g. AstraPlate) and about 20% by weight talc having a grade suitable for use in paper coatings. (e.g. Heliocoat available from Lucenac). In a further embodiment, the pigment mixture comprises about 38% by weight delaminated clay (e.g. AstraPlate), about 37% by weight platey clay, (e.g. XP 8000 available from IMERYS), about 20% by weight coarse clay (e.g. KCS available from IMERYS) and about 5% by weight calcined clay (e.g. Alphatex).

The % by weight of the pigment particles having an equivalent spherical diameter of less than 2 microns is preferably at least about 60%, more preferably from about 70 to about 98% and most preferably from about 78 to about 90%. When in admixture with a second pigment, the shape factor of the first pigment is relatively high as for example equal to or greater than about 30, 35, 40, 45, 50 or 55 within the above referenced range. In the pigment mixture the relative amounts of the pigments may vary widely. For example, the amount of low shape factor pigment may be from about 0.5% by weight to about 60% by weight and the amount of high shape factor pigment is from about 20% by weight to about 95% by weight of the mixture. The amount of low shape factor pigment is preferably from about 0.5% by weight to about 30% by weight and the amount of high shape factor pigment is preferably from about 30% by weight to about 80% by weight. The amount of low shape factor pigment is more preferably from about 0.9% by weight to about20% by weight and the amount of high shape factor pigment is more preferably from about 40% by weight to about 88% by weight.

Useful second clay pigments can be obtained from commercial sources or mined from naturally occurring deposits and engineered for the required shape factors and particle distribution. For example, useful clay pigment having an shape factor greater than 14_of from and a particle (size less than 2 microns) 85 can be obtained from IMERYS under the trade name Capim GP.

As another essential ingredient, the coating composition includes a binder. The amount of binder may vary widely but is usually from about 4 to about 8% by wgt. The amount of binder is preferably from about 6 to about 8% by wgt, more preferably from about.

Useful binders may vary widely and include those typically used in coating formulations. Illustrative of useful and preferred binders are latexes such as styrene/butadiene, styrene/butadiene/acrylonitrile, or styrene/butadiene/acrylate/acrylonitrile.

Useful binders can be obtained from commercial sources or prepared by known preparative techniques. For example, useful latex styrene/butadiene binders can be obtained from BASF under the trade name Styronal 4222; useful_StyreneIbutadiene/acrylonitrile binder can be obtained from RohmNova under the trade name XL 7614.

The coating composition preferably includes a coating structure agent. As used herein, “coating structure agent’ is a cationic polymer nitrogen based polymer. Illustrative of useful coating structure agent are cationic polymers as for example polymers containing one or more quaternary ammonium functional groups. Illustrative of such materials are cationic polyamines, cationic polyethyleneimines, copolymers of diallyldimethyl ammonium chloride (DADMAC), copolymers of vinyl pyrrolidone with quaternized diethylaminoethylmethacrylate (DEAMEMA), cationic polyurethane latex, cationic polyvinyl alcohol, polyalkylamine dicyandiamide copolymers, amine glycigyl addition polymers, poly [ox ethylene (dimethyliminio) ethylene (dimethyliminio) ethylene] dichlorides. Preferred coating structure agents are cationic polyamines.

Useful coating structure agent can be obtained from commercial sources or prepared by known preparative techniques. For example, useful polyamine coating structure agent can be obtained from BASF under the trade name Polyamine SKA.

The amount of coating structure agent may vary widely but is usually from about 0 to about 4×10⁻⁴% by wgt. The amount of coating structure agent is preferably from about 0 to about 3×10⁻⁴% by wgt, more preferably from about 0 to about 2×10⁻⁴% by wgt and most preferably from about 0 to about 2×10⁻⁴% by wgt.

In addition to the required essential pigments and polymeric or co polymeric binders, the mixture may include other ingredients except for a pigment typically applied to the surface of a recording sheet in conventional amounts. Such optional components include dispersants, fluorescent dyes, surfactants, deforming agents, preservatives, talc, bentonite, and the like. The coating agent can also include an “ink reactive material” is a substance that ensures that the ink remains on the surface of the paper rather than being absorbed into the paper. A preferred ink reactive material is water-swellable clay such as bentonite. (e.g. Printosol from Sud-Chemie) In an alternative embodiment, the water-swellable clay is replaced with a commercially available precipitated silicate such as sodium magnesium aluminosilicate. (e.g. Hydex P from Huber Engineered Materials).

In the second step of the process of this invention, the aqueous coating formulation is applied to one or both surfaces of a paper substrate using a metered size press. Methods and apparatuses for applying a coating formulation to a paper substrate using a metered size press are well known in the paper and paperboard art. See for example, G. A. Smook referenced above and references cited therein all of which is hereby incorporated by reference. All such known methods can be used in the practice of this invention and will not be described in detail. For example, the coating formulation is applied to the base paper using a metered size press of a type generally used for coating LWC paper (e.g. the Optisizer MSP manufactured by Metso or Speedsizer manufactured by Voith). The coating is applied to one or both sides of the base paper at conventional MSP coating speeds as for example at a speed of about 1000 to 2000 meters per minute.

The weight of the coating on the surface of a substrate may vary widely and any conventional coat weight can be used. In general, the coat weight is at least about 4 g/m² of recording sheet. The coat weight is preferably from about 3 g/m² to about 11 g/m^{2,} per side, more preferably from about 4 g/m² to about 10 g/m² per side and most preferably from about 7 g/m² to about 9 g/m² per side.

Any conventional paper or paperboard web can be used in the practice of this invention. Such webs and methods and apparatus for their manufacture are well known in the art. See for example G. A. Smook referenced above and references cited therein. For example, the paper and paperboard web can made from pulp fibers derived from hardwood trees, softwood trees, or a combination of hardwood and softwood trees prepared for use in a papermaking funish by any known suitable digestion, refining, and bleaching operations as for example known mechanical, thermo mechanical, chemical and semi chemical, etc., pulping and other well known pulping processes. In certain embodiments, at least a portion of 3he pulp fibers may be provided from non-woody herbaceous plants including, but not limited to, kenaf, hemp, jute, flax, sisal, or abaca although legal restrictions and other considerations may make the utilization of hemp and other fiber sources impractical or impossible. Either bleached or unbleached pulp fiber may be utilized in the process of this invention. Recycled pulp fibers are also suitable for use. In a preferred embodiment, the cellulosic fibers in the paper include from about 30% to about 100% by weight dry basis softwood fibers and from about 70% to about 0% by weight dry basis hardwood fibers.

The paper preferably comprises from about 40% to 85% by weight mechanical pulp and about 0% to 50% by weight chemical pulp. The paper more preferably comprises from about 50% to about 80% by weight mechanical pulp and from about 50% to about 30% by weight chemical pulp and most preferably comprises from about 60% to about 70% by weight mechanical pulp and from about 40% to about 30% by weight chemical pulp.

The web may also include other conventional additives such as, for example, starch, mineral fillers, sizing agents, retention aids, and strengthening polymers. Among the fillers that may be used are organic and inorganic pigments such as, by way of example, polymeric particles such as polystyrene latexes and polymethylmethacrylate, and minerals such as calcium carbonate, kaolin, and talc and expanded and expandable micro spheres. Other conventional additives include, but are not restricted to, wet strength resins, internal sizes, dry strength resins, alum, fillers, pigments and dyes.

The Gurley porosity of the base substrate as is measured by the procedure of TAPPI T460 om-88 is at least about 15-sec/100 ml. In the preferred embodiments of this invention, the substrate has Gurley porosity preferably from about 20-sec/100 cm³ to about 80-sec/100 cm³. The Gurley porosity is more preferably from about 25-sec/100 cm³ to about 70-sec/100 cm³ and most preferably from about 3 5-sec/100 cm³ to about 56-sec/100 cm³.

The pore diameter of the substrate as measured by the procedure of Mercury porosimetry described by Larrondo (1995 TAPPI Coating Conference Proceedings, pages 79-93) is at least about 3.00. In the preferred embodiments of this invention, the substrate has a pore diameter is preferably from about 3.00 to about 2.50. The pore diameter is more preferably from about 2.5 to about 2.0 and most preferably from about 1.8 to about 1.9.

The basis weight of the substrate may vary widely and conventional basis weights may be employed depending on the paper-based product formed from the web. Preferably, the substrate basis weight is from about 30 to about 56 g/m², although substrate basis weight can be outside of this range if desired. The basis weight is more preferably from about 33 to about 49 g/m² and most preferably from about 35 to about 39 g/m².

The formation of the substrate is usually equal to or greater than about 40 (Kajaani Formation Index). The formation is preferably from about 45 to about 100, more preferably from about 50 to about 90 and most preferably from about 65 to about 80.

In step (c) of the preferred embodiment of the process of this invention, the paper or paperboard web is dried after treatment with the coating composition. Methods and apparatuses for drying paper or paperboard webs treated with a coating composition are well known in the paper and paperboard art. See for example G. A. Smook referenced above and references cited therein. Any conventional drying method and apparatus can be used. Consequently, these methods and apparatuses will not be described herein in any great detail. Preferably after drying the paper or paperboard web will have moisture content equal to or less than about 10% by wgt. The amount of-moisture in the dried paper or paperboard web is more preferably from about 5 to about 10% by wgt.

After drying the paper or paperboard web may be subjected to one or more post drying steps as for example those described in G. A. Smook referenced above and references cited therein. For example, the paper or paperboard web may be calendared improve the smoothness and other properties of the web as for example by passing the coated paper through a nip formed by a calendar roll having a temperature of about 150-300 degrees F° and a pressure of about 1000 to 2000 pounds per linear inch.

The paper produced by this invention exhibits properties that make it especially useful in rotogravure printing processes. For example, the smoothness, print gloss and missing dot level of the coated papers were comparable to commercially available blade coated rotogravure paper. The paper preferably exhibits a smoothness (Parker at 10 kgf/cm², microns) value of less than about 1.5, more preferably from about 0.80 to 1.35 and most preferably from about 0.99 to about 1.20. The paper preferably exhibits a Heliotest (mm) value greater than about 80, more preferably from about 73 to about 95 and most preferably from about 80 to about 94. The paper preferably exhibits a print gloss at 750 (%) of greater than about 60, more preferably from about 65 to about 90 and most preferably from about 70 to about 82 as measured by the procedure of TAPPI T 480 om-99.

The coated paper of the present invention can be employed in rotogravure printing processes. One embodiment of the present invention is directed to a method of generating images on a surface of a coated paper in a rotogravure printing apparatus that comprises:

(a) Incorporating the coated paper of this invention into said apparatus; and

(b) Forming an image on a surface of said coated paper by causing ink to be expelled from said apparatus onto said treated surface of the coated paper to form a coated paper having an image on a surface thereof. Rotogravure printing processes an apparatus for use in such processes are well known, and are described in, for example, “PULP AND PAPER Chemistry and chemical Technology” 3^{rd} Edition, J. P. Casey, A WILEY-INTERSCIENCE PUBLICATION (1983), the disclosures of each of which are totally incorporated herein by reference.

The present invention will be described with references to the following examples. The examples are intended to be illustrative and the invention is not limited to the materials, conditions, or process parameters set forth in the example. Unless otherwise indicated, the amounts are in parts per hundred (pph).

### EXAMPLE I

(A) Preparation of Coating Compositions

The coating is prepared in the lab using a high shear mixer. A certain amount of water is added to the coating container, and then the first clay pigment (powder) is added under proper shear actions. Then the second clay (powder) is added to the coating with shear. After obtaining uniform pigment slurry, latex binder and the structural agent are added to the coating in that order under shear for thirty minutes. Then various coating additives are added to the coating under shear as follows:

1 An oil-water emulsion release agent (0.05 pph) (available from BASF under the trade name Sterocoll BL

2. NaOH in an amount to give pH of about 8 to 8.5.

3. A polyacrylic thickener (0.4 pph) available from BASF under the trade name Sterocoll FD

4. A calcium stearate lubricant (1 pph) available from BASF under the trade name Casan 65

5. Sodium polyacrylate—dispersant (0.15 pph)

After final mixing, the coating is ready for coating.

The physical characteristics of the coating formulations are set forth in the following Table I.

TABLE I

| Coat- | | First | | | | |
|---|---|---|---|---|---|---|
| ing | | Clay | Cationic | | | % |
| No. | Second Clay | Pigment | Polymer | Talc | Binder | Solids |
| 1 | 0 | 93.3 | 0.047 | 0 | 6.1 | 57.7 |
| | | Capim | | | | |
| | | GP) | | | | |
| 2 | 93.3 (Capim | 0 | 0.047 | 0 | 6.1 | 59.0 |
| | NP) | | | | | |
| 3 | 93.3 (Century) | 0 | 0.047 | 0 | 6.1 | 57.2 |
| 4 | 46.6 (XP | 46.6 (Capim | 0.047 | 0 | 6.1 | 54.8 |
| | 8000) | GP) | | | | |
| 5 | 93.3(Capim | 0 | 0.047 | 0 | 7.8 | 59.0 |
| | NP) | | | | | |
| 6 | 37.2 | 18.6 (KCS) | 0.047 | 0 | 6.1 | 58.4 |
| | (Astraplate) | | | | | |
| | 37.2 (XP | | | | | |
| | 8489) | | | | | |
| 7 | 37.2 | 18.6 (KCS) | 0.047 | 0 | 6.1 | 58.4 |
| | (Astraplate) | | | | | |
| | 37.2 (XP | | | | | |
| | 8489) | | | | | |
| 8 | 95.2 (Capim | 0 | 0.047 | 0 | 4.3 | 58.2 |
| | NP) | | | | | |
| 9 | 76.2 (Capim | 0 | 0.047 | 19.0 | 4.3 | 58.0 |
| | NP) | | | | | |
| 10 | 87.6 (Capim | 4.1 (RPS | 0.047 | 0 | 6.1 | 56 |
| | NP) | Vantage) | | | | |
| | | 0.9 (HP | | | | |
| | | 1055) | | | | |

The components listed in the Table I were obtained from commercial sources as follows:
(a) “Capim GP” is an engineered clay having an shape factor of 14 and is manufactured and sold by IMERYS;
(b) “Capim NP” is engineered, clay having an shape factor of 17 and is manufactured and sold by IMERYS;
(c) “Century” is engineered, clay having an shape factor of 21 and is manufactured and sold by CVRD;
(d) “XP 8000” is a clay having an shape factor of 60 and is manufactured and sold by IMERYS;
(e) “AstraPlate” is a delaminated clay having an shape factor of 35 to 40 is manufactured and sold by IMERYS;
(f) “KCS” is a low shape factor blocky clay and is manufactured and sold by IMERYS;
(g) “RPS Vantage” is titanium dioxide and is manufactured and sold by DuPont; and
(h) “HP 1055” is hollow spherical plastic pigment and is manufactured and sold by RohmNova.

(B) Preparation of Coated Paper

Using the coating compositions of Table I, paper substrates were coated using a metered size press (Optisizer manufactured by Metso) running at 1500 meters per minute and adjusted to apply a coating weight of 7 g/m² on the felt side of the paper and 7.4 g/m² on the wire side of the paper. After coating, the coated paper was dried and then calendered using a supercalender (from MetsoInc.) at a temperature of 90-105° C. and a pressure of 1600-2500 lbf/inch. The pore diameter of the substrate was measured by the procedure of Mercury porosimetry described by Larrondo (1995 TAPPI Coating Conference Proceedings, pages 79-93). The Gurley Porosity of the substrate was measured by the procedure of TAPPI T 460 om-02. The Kajaani formation index of the substrate was measured by the procedure based on TAPPI T271 method.

The physical parameters of the coated paper used are set forth in the following Table II.

TABLE II

| | | | | Substrate | | | |
|---|---|---|---|---|---|---|---|
| | | | | Pore | | | |
| | Substrate | Substrate | | Diameter | | | |
| | Gurley | Basis | Substrate | (fiber | | | |
| Coated | Porosity, | Weight, | Formation | pore 0.5-9.3 | Mechanical | Kraft | Coating |
| Paper | s/100 ml | g/m² | (Kjanni) | microns) | Pulp, % | Pulp, % | Formulation |
| A | 55.7 | 35.1 | 77.9 | 1.810 | 69 | 39 | 1 |
| B | 55.7 | 35.1 | 77.9 | 1.810 | 69 | 39 | 2 |
| C | 55.7 | 35.1 | 77.9 | 1.810 | 69 | 39 | 3 |
| D | 55.7 | 35.1 | 77.9 | 1.810 | 69 | 39 | 4 |
| E | 55.7 | 35.1 | 77.9 | 1.810 | 69 | 39 | 5 |
| F | 55.7 | 35.1 | 77.9 | 1.810 | 69 | 39 | 6 |
| G | 55.7 | 35.1 | 77.9 | 1.810 | 69 | 39 | 7 |
| H | 35.1 | 35.4 | 68.2 | 1.925 | 69 | 39 | 8 |
| I | 35.1 | 35.4 | 68.2 | 1.925 | 69 | 39 | 9 |
| J | 27.8 | 36.4 | 51.8 | 1.932 | 64.5 | 35.5 | 10 |

(C) Evaluation of Coated Paper

The printed-paper was evaluated to determine their effective for use in rotogravure printing. The properties selected for evaluation were Heliotest skip dot (AFNOR Standard Test Method), Parker Smoothness (TAPPI T555 om-99), and Print Gloss (TAPPI T 480 om -99) which are believed to be most critical for determining the usefulness of paper in usefulness in rotogravure printing. For comparison purposes, comparable properties of several commercially available papers coated in blade coating process were also evaluated. The results are set forth in the following Table III.

TABLE III

| | | Parker | |
|---|---|---|---|
| | Skip Dot, | Smoothness | |
| Coated | (Heliotest, | at 10 kgf/cm2, | Print |
| Paper | mm) | microns | Gloss, % |
| A | 68.5 | 1.29 | 70.7 |
| B | 81.0 | 1.20 | 71.5 |
| C | 92.5 | 1.14 | 70.4 |
| D | 93.5 | 1.18 | 71.7 |
| E | 79.5 | 1.08 | 78.4 |
| F | 82.0 | 1.11 | 76.3 |
| G | 87.5 | 0.99 | 81.0 |
| H | 80.5 | 1.21 | 72.3 |
| I | 88.0 | 1.33 | 64.0 |
| J | 50.0 | 1.31 | 68.4 |
| (C)A¹ | 88.5 | 1.19 | 75.8 |

The blade-coated papers listed in the Table II were obtained from commercial sources as follows:

(1) “(C) A” is Advocate Roto Gloss and is manufactured and sold by International Paper Company.

(D) Data Analysis

Data in Tables I, II and III was analyzed to show the effect of the choice of clays on the missing dots. The results are set forth in the following Table IV.

TABLE IV

| | | | | | | Clay shape |
|---|---|---|---|---|---|---|
| Coater | Blade | MSP | MSP | MSP | MSP | factor |
| Capim GP | | 100 | | | | 14 |
| Capim NP | | | 100 | | 50 | 17 |
| Century clay | | | | 100 | | 21 |
| XP 8000 | | | | | 50 | 60 |
| Parker | 1.19 | 1.29 | 1.20 | 1.14 | 1.18 | |
| smoothness @ | | | | | | |
| 10 kgf/cm², | | | | | | |
| micron | | | | | | |
| Missing dots | 89 | 68.5 | 81 | 92.5 | 93.5 | |
| (Heliotest | | | | | | |
| value, mm) | | | | | | |

In the Table “Blade” means the a blade coater was used to coat the substrate and “MSP” means the a metered size press was used to coat the substrate.

Data in Tables I, II and III was analyzed to show the effect of the choice of clays on the missing dots. The results are set forth in the following Tables V and VI.

TABLE V

| | Base | Base | Base |
|---|---|---|---|
| | paper A | paper B | paper C |
| Formation index | 67.8 | 74.5 | 52.9 |
| Sheffield roughness | 127 | 114 | 161 |
| Parker smoothness, | 4.84 | 4.85 | 5.71 |
| @ 10 kgf/cm2, um | | | |
| Bristow water | 50 | 59.5 | 47 |
| absorption, mm | | | |
| Gurley air | 35.1 | 55.7 | 27.8 |
| resistance, s/100 cc | | | |

TABLE VI

Sample ID

| | 1 | 2 | 3 |
|---|---|---|---|
| | With base | With base | With base |
| | Paper A | Paper B | Paper C |
| Parker | 1.24 | 1.20 | 1.31 |
| smoothness, @ | | | |
| 10 kgf/cm2, um | | | |
| Skip dots | 81 | 81 | 50 |
| (Heliotest), mm | | | |

Data in Tables I, II and III was analyzed to show the effect of the choice of clays on the missing dots. The results are set forth in the following Tables VII.

TABLE VII

| | | |
|---|---|---|
| AstraPlate | 40 | 40 |
| KCS | 20 | 20 |
| XP-8489 | 40 | 40 |
| BASF 4222 | 6.5 | 6.5 |
| Sheet moisture before supercalender, % | 6.5 | 8 |
| Parker smoothness @ 10 kgf/cm² | 1.11 | 0.99 |
| Missing dots (Heliotest value, mm) | 82 | 88 |

Although the invention has been described with reference to preferred embodiments, it will be appreciated by one of ordinary skill in the art that numerous modifications are possible in light of the above disclosure. For example, the present invention may be used produce a paper having similar requirements to those of rotogravure paper. In addition, the clays of the present invention may be substituted with clays having similar qualities, properties and characteristics. All such variations and modifications are intended to be within the scope and spirit of the invention.

What is claimed is:

1. A method of using a metered size press to producing a coated paper suitable for rotogravure printing that comprises steps of:
(a) Preparing an aqueous coating formulation comprising: (i) water, (ii) a first pigment having a shape factor of greater than about 15 or mixture thereof with one of more second pigments having a shape factor equal to or less than about 15 and having a pigment particle size distribution wherein at least about 80% by weight of the pigment particles have an equivalent spherical diameter of less than 2 microns, and (iii) a polymeric binder;
(b) Using a metered size press to apply the aqueous coating formulation to one or both surfaces of a paper substrate having Gurley Porosity of from about 20 sec/100 ml to about 60 sec/100 ml;
(c) Drying the coated paper to a moisture level of less than about 9%; and
(d) Calendaring the dried coated paper to form a form a dried calendared paper having a smoothness (Parker at 10 kgf/cm2, microns) value equal to or less than 1.5 and a Heliotest (mm) value equal to or greater than about 89.

2. The method of claim 1, wherein, the pigments comprising the pigment mixture have an shape factor of about 1:15 to 1:80.

3. The method of claim 1, wherein the aqueous coating formulation has a solids content of about 50% to 65% by weight.

4. The method of claim 1, wherein the weight of the coating on a side of the paper is about 7 grams per square meter.

5. The method of claim 1, wherein the aqueous coating formulation further comprises a lubricant.

6. The method of claim 1, wherein the aqueous coating formulation further comprises a thickener.

7. The method of claim 1, wherein the aqueous coating formulation further comprises a coating structure builder.

8. The method of claim 1, wherein the aqueous coating formulation further comprises a release agent.

9. The method of claim 1, wherein the metered size press applies the aqueous coating formulation to the paper at a speed of about 1500 meters per minute.

10. A coated paper suitable for use in rotogravure printing, the paper comprising:
(a) A paper substrate having a Gurley Porosity of from about 20 sec/100 ml to about 60 sec/100 ml and
(b) A coating on at least one side of said paper substrate, said coating comprising (i) Preparing an aqueous coating formulation comprising: (i) water, (ii) a first pigment having a shape factor of greater than about 15 or about 17 or mixture thereof with one of more second pigments having a shape factor less than that of the first clay pigment and equal to or less than about 15 to about 17 and having a pigment particle size distribution wherein at least about 80%, and (ii) a polymeric binder,
Said paper having a smoothness (Parker at 10 kgf/cm2, microns) value equal to or less than about 1.5 and a Heliotest (mm) value equal to or greater than about 80.

11. An aqueous coating formulation comprising: (i) water, (ii Preparing an aqueous coating formulation comprising: (i) water, (ii) a first pigment having a shape factor of greater than about 15 or about 17 or mixture thereof with one of more second pigments having a shape factor less than that of the first clay pigment and equal to or less than about 15 to about 17 and having a pigment particle size distribution wherein at least about 80%, and (ii) a polymeric binder.
